(19) United States
(12) Patent Application Publication
(10) Pub. No.: US 2012/0049460 A1
(43) Pub. Date: Mar. 1, 2012

(54) Target For Use With Arrows

(75) Inventor: Danny Little, Lamar, MO (US)

(73) Assignee: Poly-Green Foam, LLC

(21) Appl. No.: 13/217,136

(22) Filed: Aug. 24, 2011

Related U.S. Application Data
(60) Provisional application No. 61/376,550, filed on Aug. 24, 2010.

(51) Int. Cl. F41J 3/00; B27N 3/02

(52) U.S. Cl. 273/408; 156/62.2

(57) ABSTRACT

A system and method for constructing a target configured for use with arrows is provided. The method comprises the steps of grinding bales of scrap thermoplastic foam into small bits and heat boding the small bits to form foam boards. Then, the foam boards are secured to each other to form a hollow target core box that is cuboid shaped, and before the target core box is completed, fabric filler is included within a cavity of the target core box.

### CROSS-REFERENCE TO RELATED APPLICATIONS

This application claims priority to U.S. Patent Application Ser. No. 61/376,550, filed Aug. 24, 2010, the disclosure of which is incorporated herein by reference.

### BACKGROUND OF THE INVENTION

1. Field of the Invention

The invention relates generally to the field of targets. More specifically, the invention relates to the field of non-disposable targets for arrows.

2. Description of the Related Art

Targets for use with arrows are well known in the art, and both recreational and professional archers may utilize such targets for target practice. Some conventional designs use a bag which is drawn tightly over either a straw or cloth filler material. For these conventional versions the bag is placed in tension because it is physically responsible for containing the filler material.

### SUMMARY

Disclosed is a target for archery. In embodiments the target is a containing form, e.g., a box, formed of a recycled thermoplastic, the thermoplastic being one of polypropylene and polyethylene. The containing form includes a filler material including a recycled fabric material. And in embodiments there is target indicia on at least one side. The indicia can be included on a thermoplastic faceplate on the front of the containing form, or can be on a bag which encloses the filled containing form. In embodiments, a handle is provided on top of the target to facilitate transport. In yet further embodiments, the containing form is enclosed in a weather resistant, sealed plastic wrap.

A related method is also disclosed. The method involves (a) grinding bales of scrap foam into small bits and heat boding the small bits to form foam boards; (b) securing the foam boards to each other to form a cuboid shaped target core box, the target core box being generally hollow and having a cavity defined by the foam boards; (c) filling the cavity with fabric filler; and (d) enclosing the cavity.

The method can also involve (a) printing target indicia on a face plate; and (b) securing the face plate to the target core box. In alternative embodiments, the method can involve (a) printing target indicia onto a bag; and (b) adapting the target to be receivable into the bag.

### BRIEF DESCRIPTION OF THE SEVERAL VIEWS OF THE DRAWINGS

Illustrative embodiments of the present invention are described in detail below with reference to the attached drawing figures, wherein:

FIG. 1 is a perspective view of a target according to the present invention;

FIG. 2 is a photograph showing bales of scrap foam that are used in the manufacture of the target;

FIG. 3 is a photograph of the bales of scrap from FIG. 2 after they are ground into smaller pieces;

FIG. 4 is a photograph showing several boards that are created from the ground scrap shown in FIG. 2;

FIG. 5 is a perspective view of a target core box made and filled in accordance with the teachings of the present invention;

FIG. 6 is a perspective view showing an alternate embodiment of a completed target; and

FIGS. 7(a), 7(b), and 7(c) each show a sectional view of alternate embodiments of the target.

### DETAILED DESCRIPTION

The devices and processes disclosed herein are useful in addressing many needs in the archery world. First, the targets disclosed herein facilitate the reusability of arrows, by ensuring that the arrows do not get damaged upon impact. In other words, after an arrow has struck, it can be easily pulled out from the target and reused. Because of this, the target is itself reusable, and can be used to field scores of arrows over a long period of time.

Various factors may be relevant to a bowman in selecting a proper target. For example, the ease with which the arrows can be pulled out of the target, the probability that an arrow will not be damaged upon impact with the target or as it is pulled out, the durability of the target, its size, shape and weight, the likelihood that an arrow will not pass through the target and strike an unintended object etc are all factors that may be considered by a bowman. Moreover, factors such as the kinds of images, if any, printed on the target, the target's cost, and whether the target can easily be placed at different locations, for example, placed at a certain height above the ground, may also be relevant. In general, these targets are created with layered foam, or a bag that is filled with fabric may be used and marketed as a target.

It is generally preferred that manufactured goods be, in part or in full, created from recycled material where possible. The targets disclosed herein, in embodiments, utilize recycled materials which are able to perform admirably in function and durability.

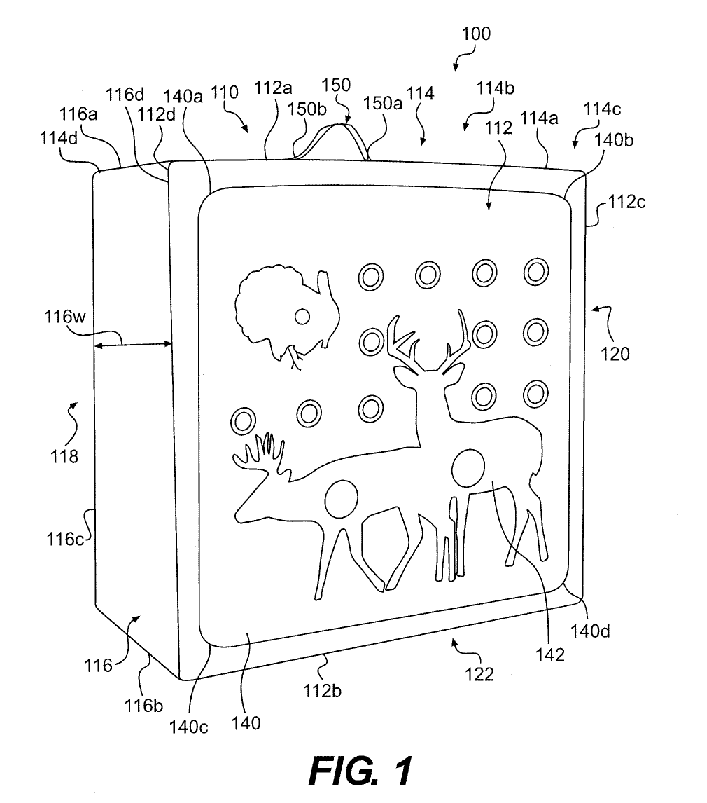

Embodiments of the present invention provide systems and a method for manufacturing targets for use with arrows. FIG. 1 shows an embodiment 100 of a target 110 in accordance with the teachings of the present invention. The target 110 has a front surface 112, a top surface 114, and a first side surface 116. A rear surface 118 opposing the front surface 112, a second side surface 120 opposing the first side surface 116, and a bottom surface 122 opposing the top surface 114 are labeled, but not clearly visible in FIG. 1.

The front surface 112 has a top edge 112a, a bottom edge 112b, and two side edges 112c and 112d. The front surface edges 112a, 112b, 112c, and 112d are generally equal in length, i.e., the front surface 112 is in the shape of a square. The side surface 116 has a top edge 116a, a bottom edge 116b, and two side edges 116c and 116d. As can be seen from FIG. 1, the target front surface side edge 112d and the target side surface side edge 116d are adjacent and equal in length, and the angle between the front surface 112 and the side surface 116 is roughly 90 degrees. The side surface top and bottom edges 116a, 116b respectively are equal in length, and the length of side surface side edges 116c and 116 is generally equal, i.e., the side surface 116 is in the shape of a rectangle. The lengths of side surface top and bottom edges 116a and 116b respectively is less than the length of side surface side edges 116c and 116d.

Similarly, the top surface 114 has a front edge 114a, and a side edge 114d. Although not clearly visible in FIG. 1, it can readily be appreciated that the top surface 114 has a rear edge 114b opposing the front edge 114a, and a side edge 114c, opposing the side edge 114d. The target top surface front edge 114a is adjacent the target front surface top edge 112a, and the angle between the top surface 114 and front surface 112 is generally 90 degrees. The target top surface side edge 114d is adjacent the target side surface top edge 116a, and the angle between the target top surface 114 and the target side surface 116 is generally 90 degrees. The length of top surface side edges 114c and 114d is generally the same, and the length of the top surface front and rear edges 114a, 114b respectively is generally equal; the length of top surface side edges 114c, 114d is less than the length of top surface front and rear edges 114a, 114b, i.e., the top surface 114 is in the shape of a rectangle.

Thus, as shown in FIG. 1, the target 110 has six faces, i.e., a front surface 112, a rear surface 118, a top surface 114, a bottom surface 122, and two side surfaces 116 and 120. The dimensions of the top surface 114, bottom surface 122, and both sides surfaces 116 and 120 are generally the same, and the dimensions of the front surface 112 and the rear surface 118 are generally equal. Hence, as two of the surfaces 112 and 118 are squares, the target 110 is substantially in the shape of cuboid which is rectangular from the side, and square front to back. It is also possible for the target surfaces 112 and 118 to not be square, and for the target 110 to be shaped like a fully rectangular cuboid (as opposed to the disclosed cuboid target). Generally, a width 116w of the target 110 is between 9 and 20 inches, and the height, i.e., the vertical distance between top and bottom edges 112a, 112b is greater than 20 inches.

The front surface 112 has a face plate 140, which has rounded corners 140a, 140b, 140c, and 140d. A similar face plate 141 is included on the back side of the target, but is not shown in FIG. 1. The face plate 140 covers a majority of the area of the target front surface 112, and has target indicia 142. The back face plate 141 (not shown), in embodiments, is front to back symmetrical to the front plate, but reflects different indicia 143. The target indicia 142 and/or 143 may include representations of animals, such as chickens or deer, in addition to other symbols and images used to represent targets, such as bulls eyes etc. The target indicia 142 may be different for different targets 110, so as to cater to different skill levels of archers. Again, although not clearly visible in FIG. 1, the target rear surface 118 also has a face plate 141, which may have different target indicia 143 than the face plate 140 on the target front surface 112. Colors of the target indicia 142, 143 and the face plates 140, 141 are generally selected so to ensure that the resulting contrast is visible from long distances. For example, the face plate 140 may be green whereas the indicia 142 may be white, ensuring that the indicia 142 is visible even when viewed from 50 yards.

A strap handle 150 on the target top surface 114 has two edges, 150a, and 150b, which are adjacent to the target top surface edges 114a and 114b respectively. The handle 150 may be used to conveniently grab a hold of, and transport the target 110.

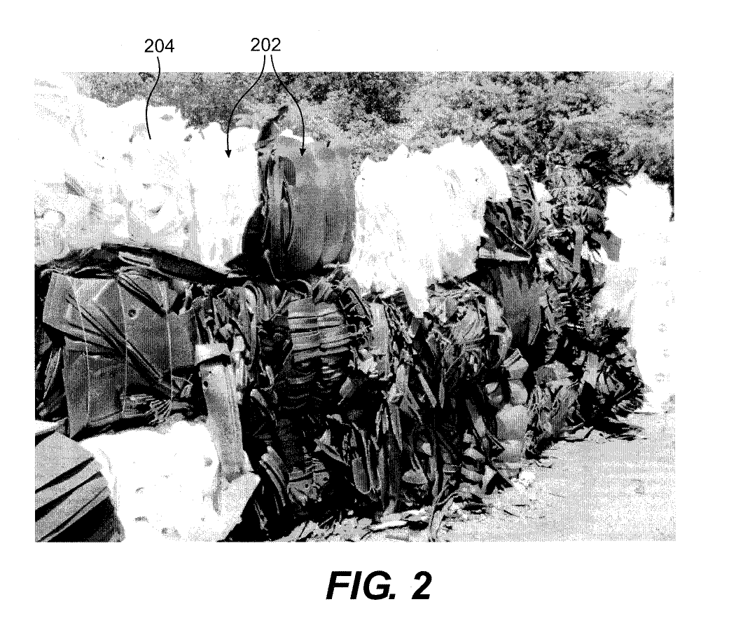

Attention is now directed to FIGS. 2-5, with the aid of which the process of creating the target 110 can be explained. FIG. 2 shows a number of bales 202 of scrap foam 204. The scrap foam 204 may comprise of polyethylene, which is a thermoplastic produced through the polymerization of ethylene. Like many long-chained polymers, polyethylene is made up of long chains of ethylene, and may have a molecular weight in the millions. The chains within polyethylene stick together through weak Van de Waal forces, and as is known in the art, polyethylene with differing densities and other material properties may be created by using different catalysts during the polymerization process. The foam 204 comprising of polyethylene is shatter proof, light weight and flexible, and is generally impervious to mildew, mold, rot and bacteria. These and other material properties of foam 204 make it an ideal candidate for use in shock absorbent applications. As discussed in more detail below, the scrap foam 204 is an essential component of the target 110, and the polyethylene used in the manufacture of the target 110 is generally post industrial closed cell cross linked high-density polyethylene.

Instead of polyethylene, or in combination therewith, the target 110 may comprise of scrap foam 204 made generally of polypropylene. Polypropylene is a thermoplastic polymer, and generally has a level of crystallinity between that of low-density polyethylene and high-density polyethylene. Other properties of polypropylene, such as its Young's modulus, also lie between the low-density and high-density polyethylene. Polypropylene is generally tough and flexible, but is subject to chain degradation from exposure to heat from molding, and ultra-violet radiation, such as that present in sunlight. Thus, in external application, such as for use in the target 110, ultra-violet absorbing additives may be added to the polypropylene. Anti-oxidants may also be added to prevent polymer degradation. The polypropylene used in scrap foam 204 is generally post industrial closed cell cross lined polypropylene.

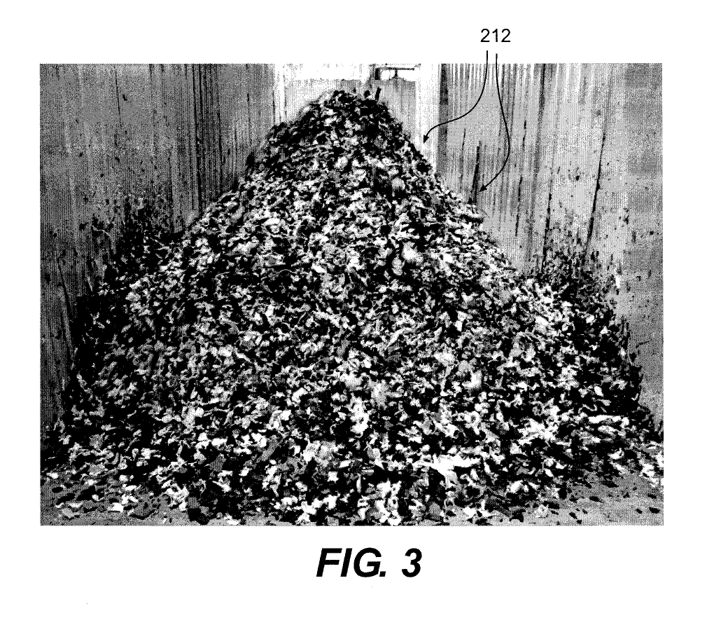

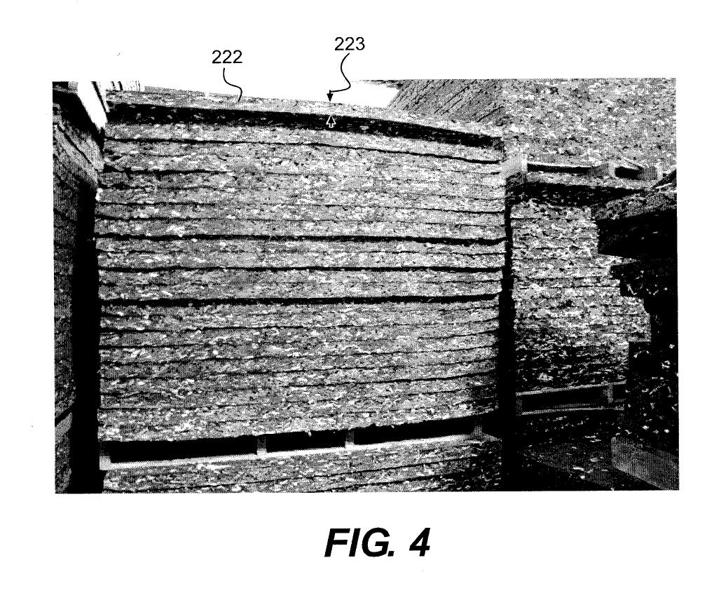

As shown in FIG. 3, the scrap foam 204 is ground into small bits 212. The grinding of the scrap foam 204 into small bits 212 may be effectuated by a variety of methods, such as by utilizing any of the commercial scrap foam grinders available on the market, or manually with tools such as shears. The bits 212 are then compressed by heat bonding, to form high density foam boards 222 as shown in FIG. 4. These foam boards 222 have a width 223 that generally ranges between 1¾ inches and 3 inches, however, for many of the embodiments, the foam boards 222 are about 2 inches wide.

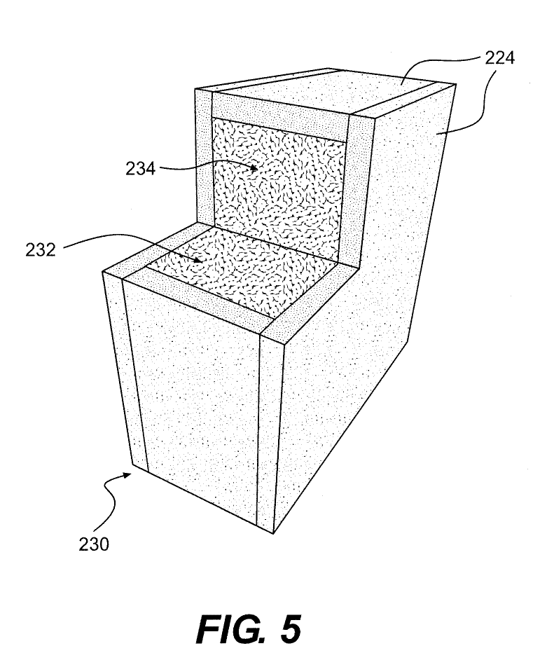

Then, the foam boards 222 are cut into six pieces 224 that are secured together to form a cuboid shaped target core box 230 (see FIG. 5). The pieces 224 may be secured together to form the core box 230 by heat bonding, glue, nails, adhesives, or any other method commonly known in the art. The target core box 230 is hollow, and has a cavity 232 within which a filler 234 can be contained; FIG. 5 shows the target core box 230 with a section cut out, such that the cavity 232 and the filler 234 are clearly visible. The filler 234 is filled into the cavity 232 before the construction of the entire target core box 230 is complete, for example, the filler 234 may be filled after five of the six pieces 224 are secured, and the sixth piece 224 may be secured thereafter.

It has been discovered that the memory foam self healing properties of the thermoplastic board materials, i.e., (i) the post industrial closed cell cross linked high-density polyethylene, (ii) post industrial closed cell cross lined polypropylene, are great for returning the target to substantially original condition after numerous arrow strikes.

The filler 234, in embodiments, is comprised of post industrial or consumer recycled fabric. In addition to the fabric, the filler 234 may also include bits 212 of scrap foam 204, which, as discussed above, may comprise of post industrial closed cell cross linked polyethylene, post industrial closed cell cross linked polypropylene, or a combination thereof.

Where the exterior thermoplastic boards slow the arrows upon initial impact, the filler materials 234 serve to ultimately stop the arrow so that it will not completely go through the target 110.

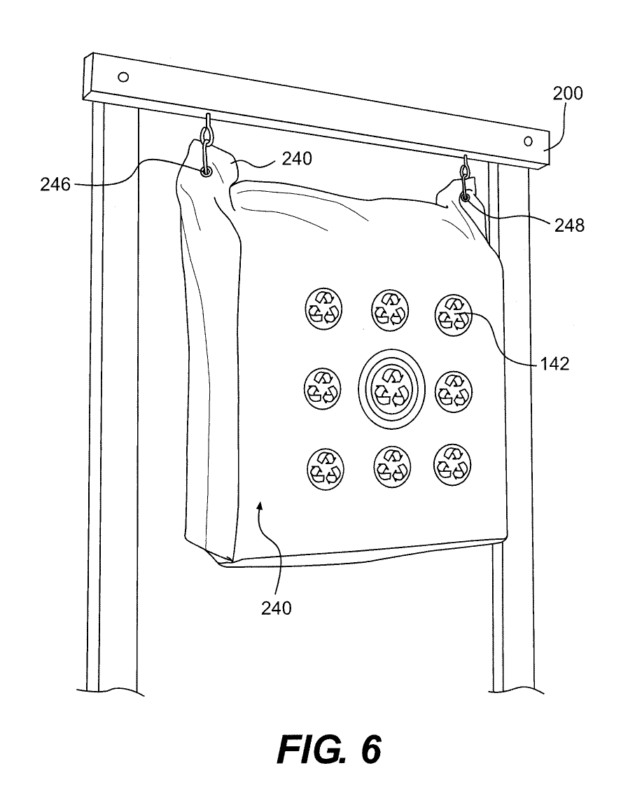

The target core box 230 can now be used as a target for arrows, and can be placed in a bag 240, as shown in an embodiment 200 outlined FIG. 6. The bag 240 may have target indicia 142 printed on both sides of the bag 240, and have additional writing, such as sponsor information etc. The bag 240 has two strategically placed small openings 246 and 248, which enable the bag 240 to be suspended from hooks or other fasteners in an upright fashion. The openings 246 and 248 may be reinforced with steel, or other suitably strong material so that the openings 246, 248 can readily support the weight of the bag 240, ensuring that the openings 246, 248 do not rip while the bag 240 is supporting the target core box 230. As scrap foam 204 is an excellent shock absorber, inclusion of bits 212 of scrap foam 204 in the filler 234 ensures that the target 110 remain steady during shooting, and as the filler 234 settles within the bag 240, it takes the pressure off the bag 240 during shooting and prevents the bag 240 from splitting.

Instead of being placed into the bag 240, the target core box 230 can be painted, and then face plates 140 (FIG. 1) can be secured to the target front and rear surfaces 112 and 118 with commercially available adhesives. The face plates 140 are generally ⅛ to ½ inches thick, and are made by heat bonding the scrap foam 204 (FIG. 2) in much the same way as the high density foam boards 222 (FIG. 4). The target indicia 142 is screen printed on the face plates 140, and as discussed, the two face plates 140, 141 may have different kinds of target indicia 142, 143 respectively.

The target 110 is then enclosed in a 6 mil thickness all weather plastic wrap, which can be sealed around the target 110 by heating. Such a plastic wrap improves the durability of the target 110 and facilitates its use in all kinds of weather, for example, by ensuring that the target 110 is generally water proof. The handle 150 may then be secured onto the top surface 114 via openings in the top surface (not shown), after small holes are made into the plastic wrap to access the top surface 114. The handle 150 may be made of a strong fabric or other suitable material, and can easily withstand the weight of the target 110 while the target 110 is being transported or moved from one place to another.

The target 110 can now be placed upright on the ground or other flat surface with bottom surface 122 adjacent the flat surface and used as a target by bowmen. The target 110, because of its construction and composition, is stable and will not topple over or change its position significantly, notwithstanding the speed or number of arrows that strike it. Moreover, this construction of the target 110 ensures that the arrows will not pass through the target 110 and strike some unintended object or being. The arrows, after they have struck the target 110, can be pulled out of the target 110 without any difficulty whatsoever, and the target 110 does not damage these arrows, allowing the arrows to be reused. The target 110 disclosed herein is durable and can last a long time, and with two face plates 140 and 141, essentially provides two different targets for use by bowmen. Moreover, as discussed, the target 110 uses recycled components in its construction, and may be preferable to other targets available on the market that do not use recycled components.

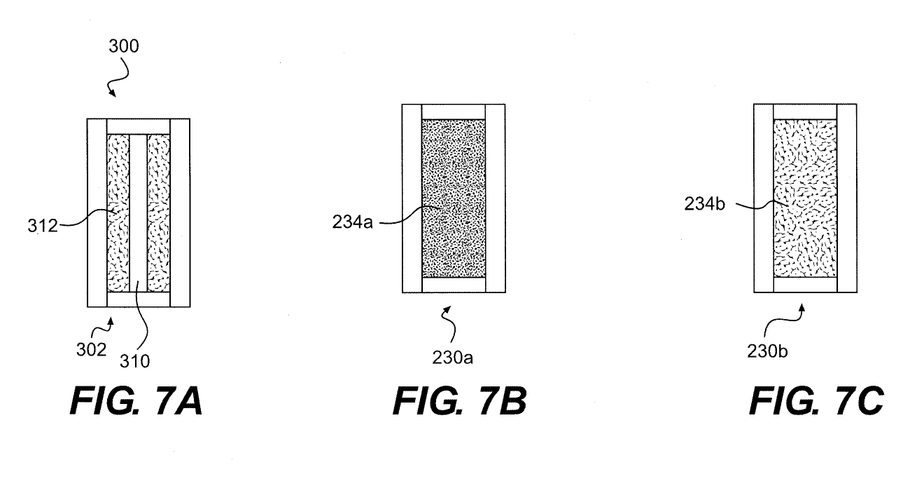

FIGS. 7(a), 7(b), and 7(c) shows certain possible variations in the construction and filling of the target core box. For example, an embodiment 300 of a target core box 302 in FIG. 7(a) includes a foam divider board 310, which acts as an additional buffer for absorbing the arrows, and further ensures that the arrows do not pass through the target core box 302. The filler 312 used in this embodiment 300 comprises generally of fabric filler material, and does not include scrap foam 204. FIG. 7(b) shows that a target core box 230a may have a filler 234a that comprises of both, scrap foam bits 212 and fabric, while a target core box 230b as shown in FIG. 7(c) may have a filler 234b, which does not include scrap foam bits 212.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A method for constructing a target configured for use with arrows, the method comprising the steps of:
(a) grinding bales of scrap foam into small bits and heat boding the small bits to form foam boards;
(b) securing the foam boards to each other to form a cuboid shaped target core box, the target core box being generally hollow and having a cavity defined by the foam boards;
(c) filling the cavity with fabric filler; and
(d) enclosing the cavity.

2. The method in claim 1, comprising the steps of:
(a) printing target indicia on a face plate; and
(b) securing the face plate to the target core box.

3. The method of claim 1 comprising:
(a) printing target indicia onto a bag; and
(b) adapting the target to be receivable into the bag.

4. An archery target comprising:
a plurality of thermoplastic walls defining a contained area;
a filler material; and;
target indicia displayed on an exterior portion outside one of the thermoplastic walls.

5. The target of claim 4 wherein the indicia is printed onto one of (i) a thermoplastic face plate, and (ii) a covering bag.

6. The target of claim 4 wherein the walls form a rectangular cuboid.

7. The target of claim 4 wherein the thermoplastic includes polyethylene.

8. The target of claim 7 wherein the polyethylene is post-industrial closed cell cross linked high density polyethylene.

9. The target of claim 4 wherein the thermoplastic includes polypropylene.

10. The target of claim 9 wherein the polypropylene is post-industrial closed-cell cross-linked polypropylene.

11. The target of claim 4 wherein the thermoplastic is a mix of polyethylene and polypropylene.

12. The target of claim 4 wherein the filler includes a cloth material.

13. The target of claim 12 wherein the cloth material is one of post industrial or consumer recycled fabric.

14. The target of claim 13 wherein the filler also includes scrap thermoplastic material bits.

15. The target of claim 4 wherein the contained area includes a divider wall constructed of one of polyethylene and polypropylene.

16. An archery target comprising:
a box formed of a recycled thermoplastic, said thermoplastic being one of polypropylene and polyethylene;
a filler material including a recycled fabric material; and
target indicia on at least one side of the box.

17. The target of claim 16 wherein said indicia is supported on one of a thermoplastic faceplate on the front of the box or a bag which encloses said box.

18. The target of claim 16 including a handle on top.

19. The target of claim 16 wherein the box is enclosed in a weather resistant, sealed plastic wrap.
